(19) United States
(12) Patent Application Publication
(10) Pub. No.: US 2003/0058482 A1
(43) Pub. Date: Mar. 27, 2003

(54) Image processor and image processing method

(76) Inventor: Hiroyuki Morimatsu, Kurume-shi (JP)

Correspondence Address: STEVENS, DAVIS, MILLER & MOSHER, LLP, 1615 L Street, N.W., Suite 850, Washington, DC, 20036, US

(21) Appl. No.: 09/852,056

(22) Filed: May 10, 2001

(30) Foreign Application Priority Data
May 15, 2000 (JP) 2000-141510

(51) Int. Cl. H04N 1/40

(52) U.S. Cl. 358/457

(57) ABSTRACT

An image processor for preventing generation of an array of dots iteratively arranged and generation of a growth pattern of dots regularly arranged in an image after binarized. The processor includes a pixel data acquisition part for acquiring image data stored in an image memory on a pixel-by-pixel basis, and a dither matrix having energy focused dots positioned in the respective cells and arranged irregularly with a non-iterative property. The processor is adapted to acquire threshold value data from the dither matrix on the basis of an address of the image data and comparing the image data of the pixel unit with the threshold value data to output a predetermined binary signal.

### BACKGROUND OF THE INVENTION

The present invention relates to an image processor and more particularly, to an image binarizing technique which is used for printers, scanners, copying machines, facsimile apparatuses or the like for reconstructing or reproducing multi-valued color image information in the form of a binary image.

Prior art methods for converting a multi-level gradation image into a binary image include a binarizing device based on an ordered dither method (which will sometimes be referred to also as the dither method, hereinafter). Explanation will now be made as to a binarizing device based on the prior art order dither method. FIG. 10 is a block diagram showing the arrangement of a prior art binarizing device based on the order dither method. FIG. 11 is a diagram showing an exemplary prior art dither matrix based on the dither method. In FIG. 10, the binarizing device includes a dither matrix memory means 3 for outputting a threshold value data T corresponding to a coordinate point of image data 1, and a comparator 2 for comparing density or gradation level data D of the image data 1 with the threshold value data T to output a predetermined binary signal. The image data 1 binarized for a printer is image data having four color components of black, cyan, magenta and yellow.

The dither matrix memory means 3 stores therein a dither matrix as a table of threshold values as shown in FIG. 11. This is an example of the dither matrix used when the image data 1 has a gradation of 256 density levels of 0-255. In the prior art, the matrix data are designed so that dots are regularly arranged according to its generation rule. And the comparator 2 compares the density data D of each pixel of each color component in the image data 1 with the threshold value data T corresponding to the coordinate point of the image data 1 in such a manner that, when D>T, the comparator outputs a binary signal as an ON dot, whereas, when D<T, the comparator outputs a binary signal as an OFF dot. When such operations are carried out over all pixel data of the respective color components in the image data, binary image data is eventually generated.

In the binary image apparatus for generating binary image data according to the above dither method, it is well known that generation of a pseudo contour in a particular density region or generation of a texture causes reduction of a gradations performance or deterioration of an image quality.

Further, in an edge region, reduction in edge sharpness called jaggy inherent in the dither method takes place, which results in remarkable reduction of its edge reproducibility.

When an input image is of a dot pattern type, moire as interference fringes takes place in an image after binarized by the dither method, which undesirably causes deterioration of the image quality.

These problems result from a dot pattern generated by the dither method. More specifically, an array of iteratively arranged dots or a growth pattern of regular dots generated in an image after binarized in the dither method results in texture generation, pseudo contour generation, reduction of edge reproducibility caused by jaggy in an edge region, and generation of moire caused by the interference with the dots.

### SUMMARY OF THE INVENTION

It is therefore an object of the present invention to provide an image processor which can prevent generation of an array of iteratively arranged dots and generation of regular growth patterns of dots in an image after binarized.

According to a first aspect of the present invention, an image processor includes an image memory for storing multi-valued image data therein, pixel data acquisition means for acquiring the image data stored in the image memory on a pixel-by-pixel basis, dither matrix storage means for storing a dither matrix having energy focused dots positioned in respective cells and arranged irregularly with a non-iterative property, threshold value data acquisition means for acquiring threshold value data corresponding to the image data from the dither matrix storage means on the basis of an address of the image data inputted from the pixel data acquisition means, and a comparator for comparing the image data of the pixel unit inputted from the pixel data acquisition means with the threshold value data inputted from the threshold value data acquisition means to output a predetermined binary signal.

Since this provides irregular dot arrangement, generation of an array of iteratively arranged dots and generation of a growth pattern of dots in an image after binarized can be avoided.

According to a second aspect of the present invention, as recited in appended claim 2, in the above first aspect, the dither matrix is divided into a plurality of cells, dot growth is made by arranging dots in each cell as concentrated and making dot growth patterns mutually different. Since the dot growth patterns of the cells are made irregularly, generation of an array of dots iteratively arranged and generation of regular dot growth patterns in an image after binarized can be advantageously prevented.

According to a third aspect of the present invention, as recited in appended claim 3, in the above second aspect, the dots in the cells are grown as concentrated around their energy focused dots irregularly positioned. Since dots having shapes different for different cells are generated from the respective energy focused dots irregularly positioned, generation of an array of dots regularly arranged and generation of regular dot growth patterns in an image after binarized can be advantageously prevented.

According to a fourth aspect of the present invention, as recited in appended claim 4, in the above first aspect, the dots are arranged in each cell so that an inter-dot density becomes most uniform. As a result, dispersion of energy focused dots can be improved and thus texture generation can be advantageously reduced.

According to a fifth aspect of the present invention, as recited in appended claim 5, in the above fourth aspect, a density between the dots in each cell is calculated on the basis of distances between energy focused dots positioned in the respective cells. As a result, dot arrangement taking the uniformity of energy focused dots into consideration can be advantageously realized.

According to a sixth aspect of the present invention, as recited in appended claim 6, in the above second aspect, the dots in the each cell are grown in a dot growth pattern so as to be most uniform in density with respect to dots to be generated in the cell adjacent to the cell of interest. Since the uniformity in dot density between adjacent cells can be maintained, growth patterns of dots having reduced texture generation and having a good dispersion can be advantageously generated.

According to a seventh aspect of the present invention, as recited in appended claim 7, in the above sixth aspect, the dot density in the cell of interest is calculated on the basis of distances from dots in the cells adjacent to the cell of interest. As a result, a density with dots to be generated in the adjacent cell can be accurately calculated and dot dispersion can be advantageously improved.

According to an eighth aspect of the present invention, as recited in appended claim 8, in the above first aspect, the threshold values are set in the dither matrix so that an average of set values in the each cell is an intermediate value of density levels in the image data. Since a distribution of the threshold values in the cells becomes uniform in the entire dither matrix, a good quality of reproduced image can be advantageously obtained.

According to a ninth aspect of the present invention, as recited in appended claim 9, in the above first aspect, the threshold values in the dither matrix are set differently in the different cells of the dither matrix. As a result, generation of a pseudo contour can be advantageously suppressed by increasing the number of gradation levels.

According to a tenth aspect of the present invention, as recited in appended claim 10, in the above first aspect, the dots are set at any of a plurality of particular positions in the cells of the dither matrix. Since energy focused dots are positioned strongly randomly and image quality is deteriorated, a high quality of image can be advantageously reproduced.

According to an eleventh aspect of the present invention, as recited in appended claim 11, in the above second aspect, the growth patterns of the dots in the cells of the dither matrix are made to have an identical shape when a variation in the dot shape at the time of generating an identical size of dots causes a printing density of an actual printer to be largely changed. Since print unstability in the printer can be accommodated by the dot patterns, a stable printed result can be advantageously obtained.

### BRIEF DESCRIPTION OF THE DRAWINGS

FIG. 1 is a block diagram of an arrangement of an image processor using an image processing method in accordance with an embodiment of the present invention;

FIG. 2 is a flowchart showing the operation of the image processor of FIG. 1;

FIG. 3 is a flowchart showing a procedure of producing a dither matrix in the image processor of FIG. 1;

FIG. 4 is a diagram for explaining the structures of cells divided for production of a dither matrix in the image processor of FIG. 1;

FIGS. 5(A) to 5(D) show diagrams for explaining a procedure of determining a cell center position for production of the dither matrix in the image processor of FIG. 1;

FIG. 6 is a diagram for explaining how to set threshold values as an example at cell center positions for production of the dither matrix in the image processor of FIG. 1;

FIG. 7 is a diagram showing candidate points of cell centers set for production of the dither matrix in the image processor of FIG. 1;

FIG. 8 is a diagram for explaining a procedure of setting a threshold value in a cell set for production of the dither matrix in the image processor of FIG. 1;

FIG. 9 shows dot output patterns as a result of binarizing operation with use of dither matrixes in the image processor of FIG. 1;

FIG. 10 is a block diagram of an arrangement of a prior art binarizing device based on a dither method; and

FIG. 11 shows an exemplary dither matrix.

### DESCRIPTION OF THE EMBODIMENTS

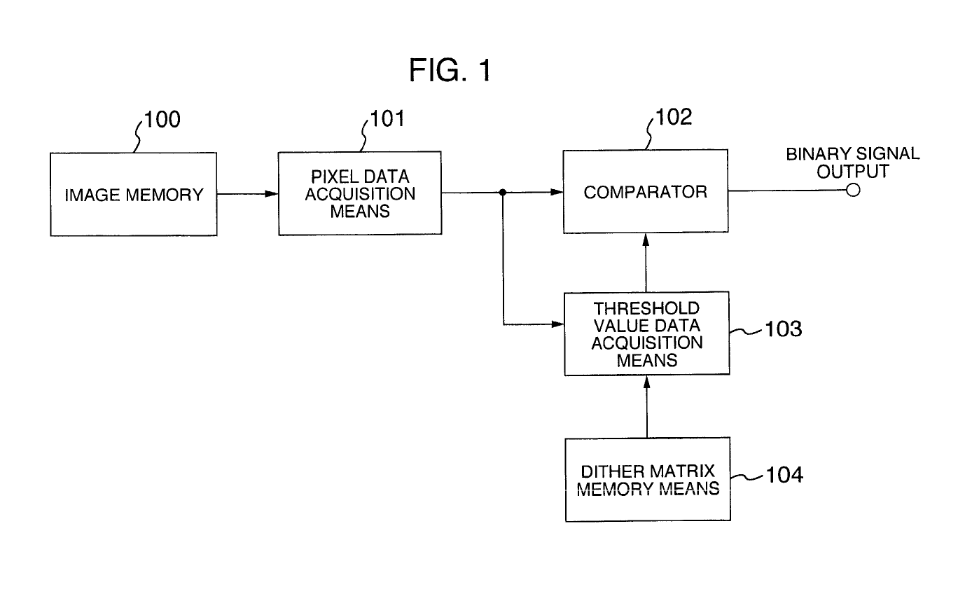

Explanation will be made as to an embodiment of the present invention with reference to FIGS. 1 to 9. In the drawings, the same members are denoted by the same reference numerals and duplicated explanation is omitted.

As shown in FIG. 1, an image processor in accordance with an embodiment of the present invention includes an image memory 100 for storing multi-valued image data to be binarized therein, a pixel data acquisition means 101 for acquiring the image data stored in the image memory 100 on a pixel-by-pixel basis, a dither matrix memory means 104 for storing a predetermined dither matrix therein, a threshold value data acquisition means 103 for acquiring threshold value data corresponding to the image data from the dither matrix memory means 104 on the basis of an address of the image data inputted from the pixel data acquisition means 101, and a comparator 102 for comparing the image data of a pixel unit inputted from the pixel data acquisition means 101 with the threshold value data inputted from the threshold value data acquisition means 103 to output a predetermined binary signal.

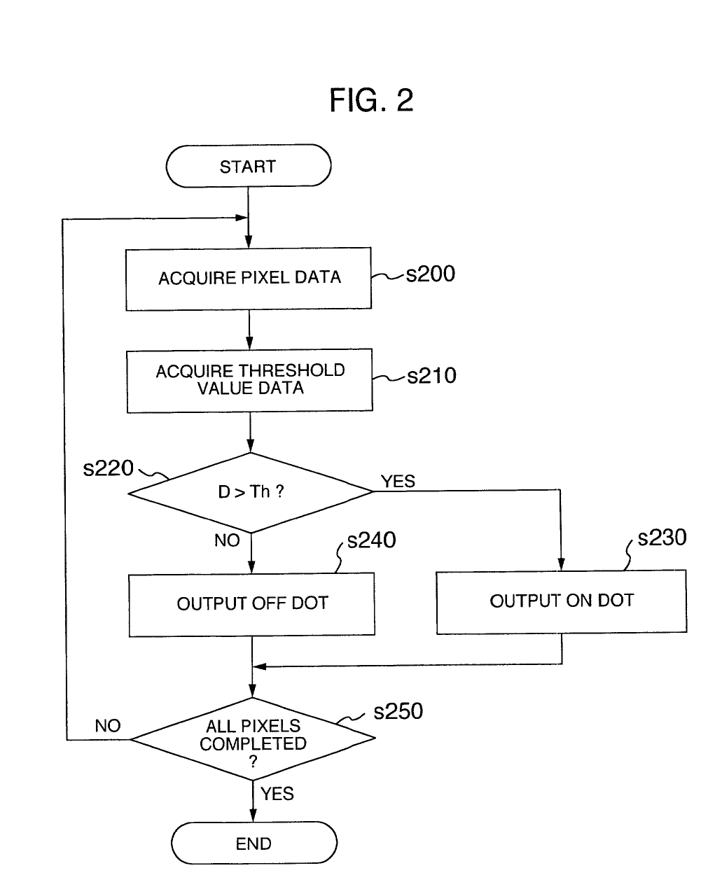

The operation of the image processor arranged in this manner will be explained by referring to a flowchart of FIG. 2.

Data D of a pixel unit is first acquired by the pixel data acquisition means 101 from image data stored in the image memory 100 (step s200), and threshold value data Th of a dither matrix stored in the dither matrix memory means 104 corresponding to the acquired pixel is acquired by the threshold value data acquisition means 103 (step s210). A means for generating a dither matrix to be used will be explained later.

Next the acquired data D is compared by the comparator 102 with the threshold value data Th (step s220) so that, when its comparison result is D>Th, the comparator outputs binary data as an ON dot (step s230), whereas, when the result is D≦Th, binary data is output as an OFF dot (step s240).

The above operations are carried out for all pixels in the inputted image data, after which the operation is completed (step s250).

Explanation will next be made as to how to generate a dither matrix.

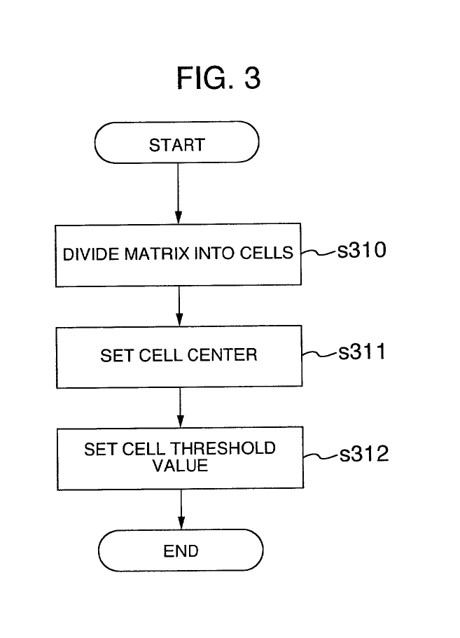

In FIG. 3, a dither matrix is first divided into cells (step s310). For each of the divided cells, next, an energy focused dot is set (step s311), which defines a center of a respective cell, and threshold value data are determined or produced on each cell center within each cell (step s312). As a result, production of a dither matrix is completed.

The above processes of producing the dither matrix will be explained in more detail.

First of all, explanation will be made as to the shape and assignment of cells divided from the dither matrix at the step s310 in FIG. 3.

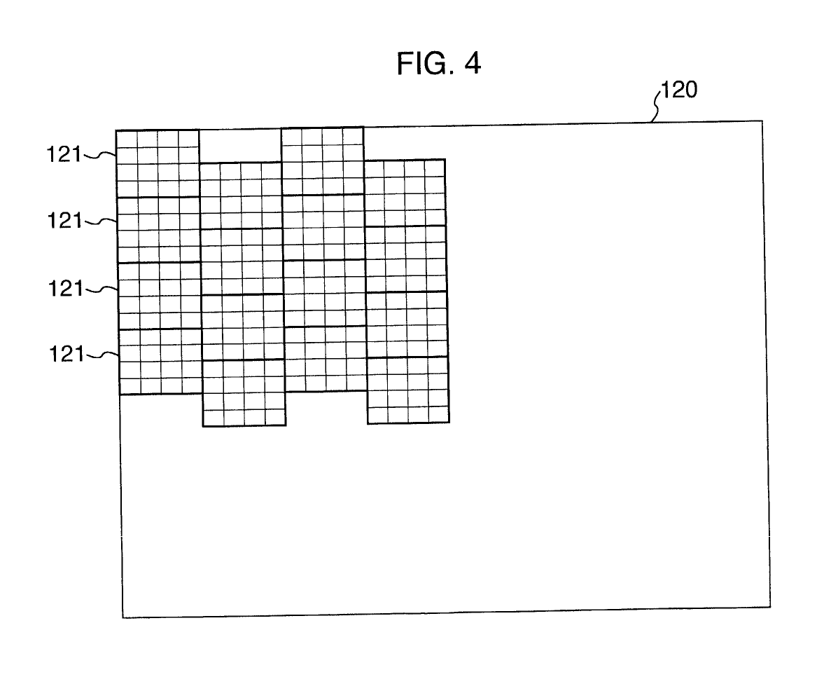

In FIG. 4, reference numeral 210 denotes the entire region of a dither matrix, and numeral 121 denotes each of cells into which the dither matrix is divided. The cells each have an identical shape of squares of 4×4 dots, but the dither matrix may be divided into cells of different sizes and shapes.

Explanation will then be made as to how to set a cell center.

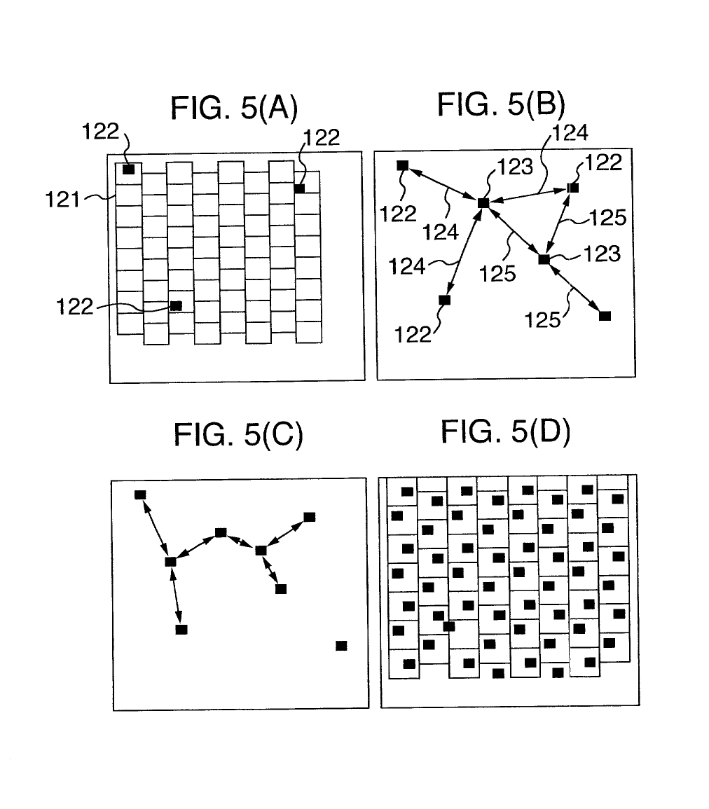

In FIG. 5(A), reference numeral 121 denotes each of cells into which the dither matrix is divided, and numeral 122 denotes a center position of each cell for initialization or initial setting. In FIG. 5(B), reference numeral 123 denotes a cell center candidate point, and numeral 124 denotes distances or inter-cell-center distances between the cell center candidate point 123 and the cell center positions 122 already set.

How to set a cell center position will be explained by referring to FIGS. 5(A) to 5(D).

In FIG. 5(A), first of all, the cell center positions 122 for initialization are set for the divided cells 121. Although three-point setting is employed in the illustrated example, 4-point, 5-point or any-number-point setting may be possible. Further, the cell center position 122 is considered to be arbitrarily changed.

As shown in FIG. 5(B), next, a position not set as the cell center position 122 is used as the next cell center candidate point 123, and the inter-cell-center distance(s) 124 between the cell center candidate point 123 and cell center position(s) 122 is(are) calculated on the basis of their addresses. And such a distance calculation is carried out for all positions to be candidate points, and a position of one of the candidate points, which has smallest or shortest one of the calculated distances with each candidate point and which has the maximum value of such shortest distances, is set as a cell center position.

After the above operations are carried out until cell center positions are set for all the cells, the cell centers are set for all the cells within the dither matrix as shown in FIGS. 5(C) and 5(D).

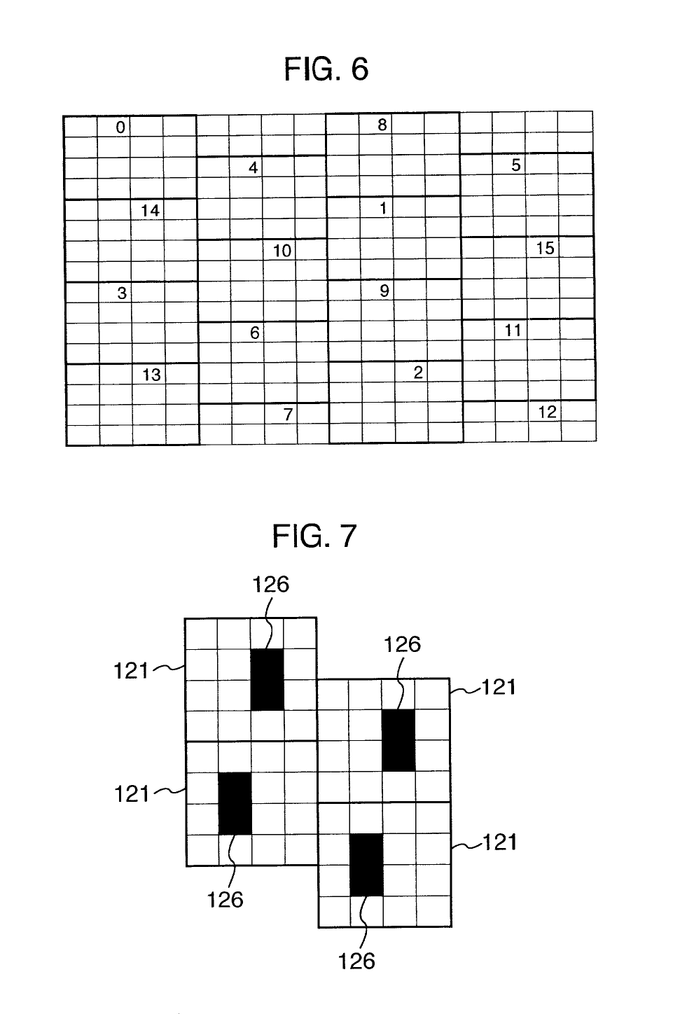

Threshold values are set for the set cell centers. FIG. 6 shows an example of threshold values set around cell centers. Setting the threshold values to different values is also considered at the time of generating a different matrix pattern. Further, when all points within a cell were set as candidate points of the cell center, the cell center position is made random very strongly. Thus an image reproduced by using the generated or produced dither matrix is considered to be made random, causing deterioration of its image quality. For this reason, when cell center candidate points 126 are set within the respective divided cells 121 as shown in FIG. 7, the random property of the cell center position can be suppressed. In this connection, various patterns may be considered even for setting of candidate points different from setting of those setting shown in FIG. 7, and thus when the setting is changed, a different dot generation pattern can be obtained.

Explanation will next be made as to a technique for setting threshold value within a cell.

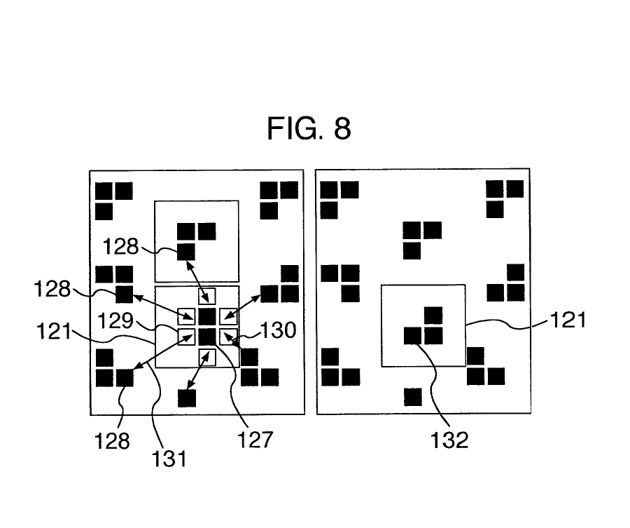

FIG. 8 shows a technique for setting threshold values in a dither matrix after cell centers are set, that is, a technique for generating dots.

In FIG. 8, reference numeral 121 denotes cells into which the dither matrix is divided and for which threshold values are to be set, and a cell center 127 is set for each cell by the aforementioned technique. Further, dots denoted by reference numeral 128 are dots which are already output, that is, to positions of which threshold values are already set. Six blank square dots denoted by numeral 129 mean positions to which dots are to be output within the cell, that is, which are candidate points for threshold values to be next set. Double arrows denoted by numerals 130 and 131 each indicate a distance between the candidate point 129 for setting of a threshold value in the cell and the position 128 having the threshold value already set therefor in a cell adjacent thereto. Numeral 132 denotes a position determined as threshold value set position.

A technique for setting threshold values within the cells under such a condition will be explained in detail below.

As mentioned above, the dither matrix is divided into the divided cells 121 for which the cell centers 127, i.e., energy focused dots are set respectively. And a dot is output to the threshold-value set position in the adjacent cell 121 and a threshold value is set thereto.

Explanation will be made as to how a next threshold value is set at which position in the cell 121.

In the cell 121, it is the six blank squares 129 which can be possible as the next candidate point. Calculation of distances of these six candidate points for setting of threshold values from adjacent dots, that is, from positions having threshold values already set thereto is carried out for all the six points. Shortest one of these distances is the inter-dot distance 130 and longest one thereof is denoted by an arrow 131. One of the six points as the threshold-value setting candidate points 129 corresponding to the shortest distance, that is, the candidate point 129 corresponding to the maximum inter-dot distance 131 in the drawing, is determined as a threshold-value setting point. As a result, a threshold value is set to the position denoted by numeral 132.

After threshold values are set for all the positions in the cell through the aforementioned operations, generation of a dither matrix is completed.

Threshold values to be set for respective candidate points are as shown in Tables 1 and 2 below, and are set with initial set values set for the aforementioned cell center positions as references.

TABLE 1
INITIAL THRESHOLD VALUE
↓

IN-CELL SET THRESHOLD VALUE

| | [symbol] | | | | | | | | | | | | | | |
|---|---|---|---|---|---|---|---|---|---|---|---|---|---|---|---|
| 0 | 16 | 32 | 48 | 64 | 80 | 96 | 112 | 143 | 159 | 175 | 191 | 207 | 223 | 239 | 255 |
| 1 | 17 | 33 | 49 | 65 | 81 | 97 | 113 | 142 | 158 | 174 | 190 | 206 | 222 | 238 | 254 |
| 2 | 18 | 34 | 50 | 66 | 82 | 98 | 114 | 141 | 157 | 173 | 189 | 205 | 221 | 237 | 253 |
| 3 | 19 | 35 | 51 | 67 | 83 | 99 | 115 | 140 | 156 | 172 | 188 | 204 | 220 | 236 | 252 |
| 4 | 20 | 36 | 52 | 68 | 84 | 100 | 116 | 139 | 155 | 171 | 187 | 203 | 219 | 235 | 251 |
| 5 | 21 | 37 | 53 | 69 | 85 | 101 | 117 | 138 | 154 | 170 | 186 | 202 | 218 | 234 | 250 |
| 6 | 22 | 38 | 54 | 70 | 86 | 102 | 118 | 137 | 153 | 169 | 185 | 201 | 217 | 233 | 249 |
| 7 | 23 | 39 | 55 | 71 | 87 | 103 | 119 | 136 | 152 | 168 | 184 | 200 | 216 | 232 | 248 |
| 8 | 24 | 40 | 56 | 72 | 88 | 104 | 120 | 135 | 151 | 167 | 183 | 199 | 215 | 231 | 247 |
| 9 | 25 | 41 | 57 | 73 | 89 | 105 | 121 | 134 | 150 | 166 | 182 | 198 | 214 | 230 | 246 |
| 10 | 26 | 42 | 58 | 74 | 90 | 106 | 122 | 133 | 149 | 165 | 181 | 197 | 213 | 229 | 245 |
| 11 | 27 | 43 | 59 | 75 | 91 | 107 | 123 | 132 | 148 | 164 | 180 | 196 | 212 | 228 | 244 |
| 12 | 28 | 44 | 60 | 76 | 92 | 108 | 124 | 131 | 147 | 163 | 179 | 195 | 211 | 227 | 243 |
| 13 | 29 | 45 | 61 | 77 | 93 | 109 | 125 | 130 | 146 | 162 | 178 | 194 | 210 | 226 | 242 |
| 14 | 30 | 46 | 62 | 78 | 94 | 110 | 126 | 129 | 145 | 161 | 177 | 193 | 209 | 225 | 241 |
| 15 | 31 | 47 | 63 | 79 | 95 | 111 | 127 | 128 | 144 | 160 | 176 | 192 | 208 | 224 | 240 |

TABLE 1
INITIAL THRESHOLD VALUE
↓

IN-CELL SET THRESHOLD VALUE

| | [symbol] | | | | | | | | | | | | | | |
|---|---|---|---|---|---|---|---|---|---|---|---|---|---|---|---|
| 0 | 16 | 32 | 48 | 64 | 80 | 96 | 112 | 143 | 159 | 175 | 191 | 207 | 223 | 239 | 255 |
| 1 | 30 | 33 | 62 | 65 | 94 | 97 | 126 | 129 | 158 | 161 | 190 | 193 | 222 | 225 | 254 |
| 2 | 29 | 34 | 61 | 66 | 93 | 98 | 125 | 130 | 157 | 162 | 189 | 194 | 221 | 226 | 253 |
| 3 | 28 | 35 | 60 | 67 | 92 | 99 | 124 | 131 | 156 | 163 | 188 | 195 | 220 | 227 | 252 |
| 4 | 27 | 36 | 59 | 68 | 91 | 100 | 123 | 132 | 155 | 164 | 187 | 196 | 219 | 228 | 251 |
| 5 | 26 | 37 | 58 | 69 | 90 | 101 | 122 | 133 | 154 | 165 | 186 | 197 | 218 | 229 | 250 |
| 6 | 25 | 38 | 57 | 70 | 89 | 102 | 121 | 134 | 153 | 166 | 185 | 198 | 217 | 230 | 249 |
| 7 | 24 | 39 | 56 | 71 | 88 | 103 | 120 | 135 | 152 | 167 | 184 | 199 | 216 | 231 | 248 |
| 8 | 23 | 40 | 55 | 72 | 87 | 104 | 119 | 136 | 151 | 168 | 183 | 200 | 215 | 232 | 247 |
| 9 | 22 | 41 | 54 | 73 | 86 | 105 | 118 | 137 | 150 | 169 | 182 | 201 | 214 | 233 | 246 |
| 10 | 21 | 42 | 53 | 74 | 85 | 106 | 117 | 138 | 149 | 170 | 181 | 202 | 213 | 234 | 245 |
| 11 | 20 | 43 | 52 | 75 | 84 | 107 | 116 | 139 | 148 | 171 | 180 | 203 | 212 | 235 | 244 |
| 12 | 19 | 44 | 51 | 76 | 93 | 108 | 115 | 140 | 147 | 172 | 179 | 204 | 211 | 236 | 243 |
| 13 | 18 | 45 | 50 | 77 | 82 | 109 | 114 | 141 | 146 | 173 | 178 | 205 | 210 | 237 | 242 |
| 14 | 17 | 46 | 49 | 78 | 81 | 110 | 113 | 142 | 145 | 174 | 177 | 206 | 209 | 238 | 241 |
| 15 | 16 | 47 | 48 | 79 | 80 | 111 | 112 | 143 | 144 | 175 | 176 | 207 | 208 | 239 | 240 |

In this case, preparation of two types of threshold-value set patterns is for the purpose of reducing regularity. When not only two types but also three or more types of set patterns are prepared and set as switched for cells, an improvement in a gradation performance can be advantageously expected.

The set threshold value may be set so that an average of values set within cells is an intermediate value of multi-valued level widths of a density of an input image. In other words, when an input image has levels of 0 to 255, an average of threshold values in a cell is set to be the cell center 127.

With regard to even dot generation shape, by changing setting of the candidate points 129 for setting of threshold values, it can be avoided that dots having different shapes are mixed, that is, it is also possible to output dots having an identical shape at the time of outputting an identical number of dots.

Further, although a dot concentration type dither matrix having energy focused dots provided therein has been generated in the present embodiment, in place of the dot concentration type, a dot dispersion type dither matrix wherein dots are not concentrated but dispersed may also be generated by setting the threshold-value setting candidate points 129 to positions not adjacent to dots.

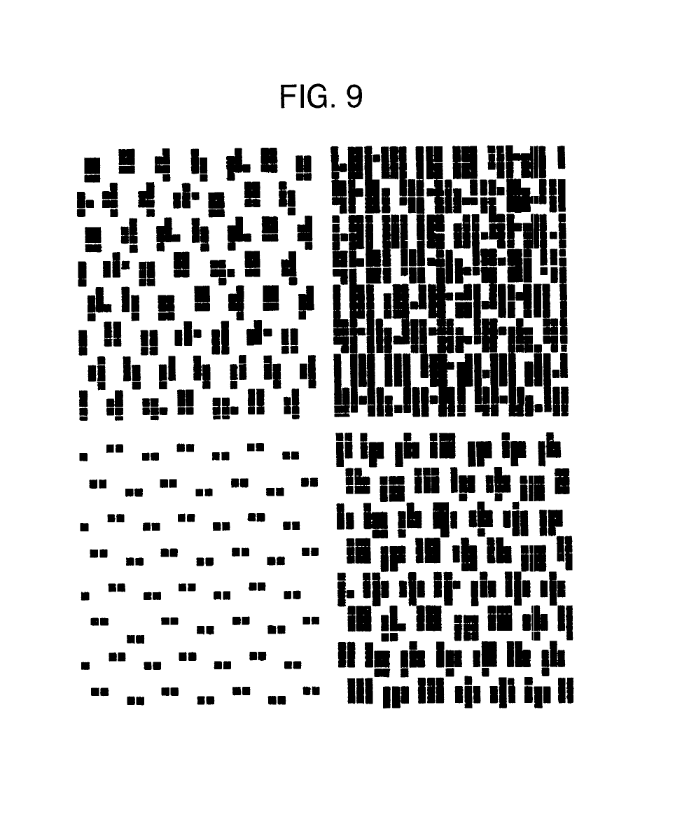

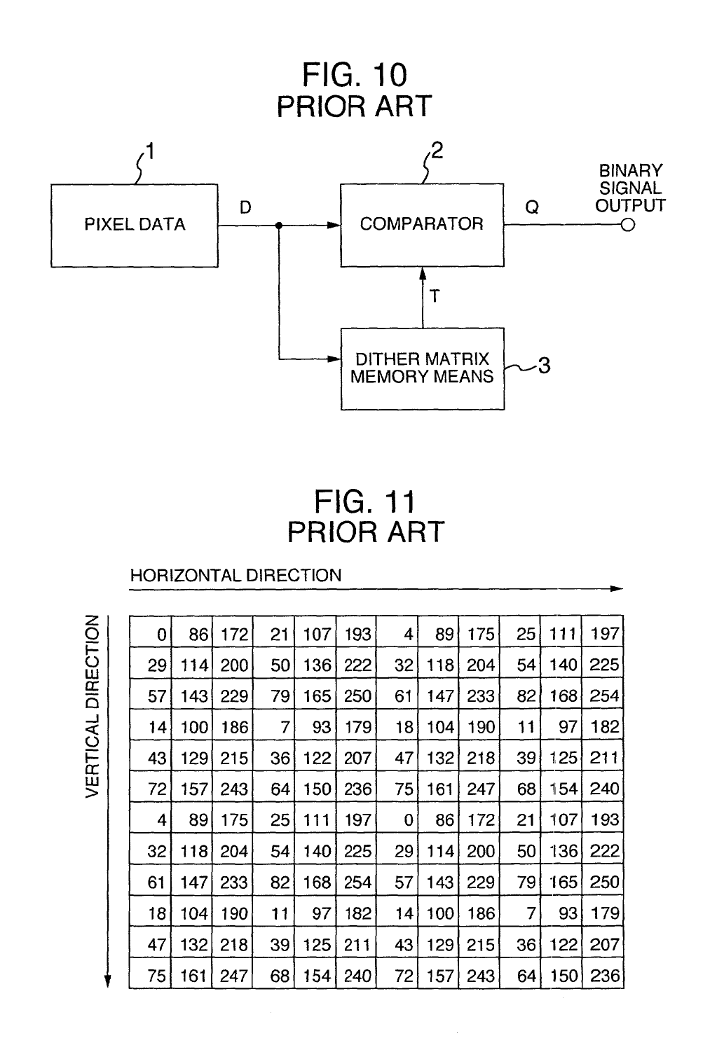

Constitutions of the above-mentioned dither matrix may be implemented and formed by using personal computers, etc. As a result of binarization with use of such a dither matrix generated by the aforementioned technique, such a dot output patterns as shown in FIG. 9 is obtained. As illustrated, it will be seen that the output patterns have non-iterative coordinate points and cell shapes are generated irregularly.

In this way, in accordance with the present embodiment, generation of an iterative array of dots and generation of a regular growth pattern of dots in an image after binarized can be prevented.

Thereby texture generation, pseudo contour generation, jaggy generation in an edge region and moire generation can be avoided.

As has been explained in the foregoing, in accordance with the present invention, since a dot pattern having non-iterative dot coordinate points can be output, iterative dot assignment and a growth pattern of dots regularly arranged in an image after binarized can be effectively avoided.

As a result, texture generation, pseudo contour generation, jaggy generation in an edge region and moire generation can be effectively avoided.

Further, since the cell center setting and threshold value setting in a cell can realize highly regular dot assignment with the inter-dot distance considered, dot dispersion can be improved and a high quality of image can be effectively realized.

Furthermore, since dot shape can be generated according to the printing characteristics of a printer, a dither matrix for dot generation optimum for the printing characteristics of various types of printers can be effectively generated.

What is claimed is:

1. An image processor comprising:
an image memory for storing multi-valued image data therein;
pixel data acquisition means for acquiring the image data stored in said image memory on a pixel-by-pixel basis;
dither matrix storage means for storing a dither matrix having energy focused dots positioned in respective cells and arranged irregularly with a non-iterative property;
threshold value data acquisition means for acquiring threshold value data corresponding to the image data from the dither matrix storage means on the basis of an address of the image data inputted from said pixel data acquisition means; and
a comparator for comparing the image data of the pixel unit inputted from said pixel data acquisition means with the threshold value data inputted from said threshold value data acquisition means to output a predetermined binary signal.

2. An image processor as set forth in claim 1, wherein said dither matrix is divided into a plurality of cells, dot growth is made by arranging dots in each cell as concentrated and making dot growth patterns mutually different.

3. An image processor as set forth in claim 2, wherein said dots in the cells are grown as concentrated around their energy focused dots irregularly positioned.

4. An image processor as set forth in claim 1, wherein said dots are arranged in each cell so that an inter-dot density becomes most uniform.

5. An image processor as set forth in claim 4, wherein a density between said dots in each cell is calculated on the basis of distances between energy focused dots positioned in said respective cells.

6. An image processor as set forth in claim 2, wherein said dots in said each cell are grown in a dot growth pattern so as to be most uniform in density with respect to dots to be generated in the cell adjacent to the cell of interest.

7. An image processor as set forth in claim 6, wherein said dot density in the cell of interest is calculated on the basis of distances from dots in the cells adjacent to the cell of interest.

8. An image processor as set forth in claim 1, wherein said threshold values are set in said dither matrix so that an average of set values in said each cell is an intermediate value of density levels in said image data.

9. An image processor as set forth in claim 1, wherein said threshold values in said dither matrix are set differently in said different cells of the dither matrix.

10. An image processor as set forth in claim 1, wherein said dots are set at any of a plurality of particular positions in said cells of said dither matrix.

11. An image processor as set forth in claim 2, wherein said growth patterns of said dots in said cells of said dither matrix are made to have an identical shape when a variation in the dot shape at the time of generating an identical size of dots causes a printing density of an actual printer to be largely changed.

12. An image processing method comprising the steps of:
storing multi-valued image data in a memory;
acquiring image data stored in the memory on a pixel-by-pixel basis;
storing in storage means a dither matrix having energy focused dots positioned in respective cells and arranged irregularly with a non-iterative property;
acquiring from the dither matrix threshold value data corresponding to the acquired image data on the basis of an address of the acquired image data; and
comparing the acquired image data of the pixel unit with the acquired threshold value data in order to output a predetermined binary signal.

13. A method of claim 1, wherein said dither matrix is divided into a plurality of cells, dot growth is made by arranging dots in each cell as concentrated and making dot growth patterns mutually different.

14. A method of claim 1, wherein a density between said dots in each cell is calculated on the basis of distances between energy focused dots positioned in said respective cells.

15. A method of claim 13, wherein said dots in said each cell are grown in a dot growth pattern so as to be most uniform in density with respect to dots to be generated in the cell adjacent to the cell of interest.

16. A method of claim 15, wherein said dot density in the cell of interest is calculated on the basis of distances from dots in the cells adjacent to the cell of interest.
